(19) United States
(12) Patent Application Publication
(10) Pub. No.: US 2015/0287354 A1
(43) Pub. Date: Oct. 8, 2015

(54) ERROR-DIFFUSION BASED TEMPORAL DITHERING FOR COLOR DISPLAY DEVICES

(71) Applicant: QUALCOMM Mems Technologies, Inc., San Diego, CA (US)

(72) Inventors: Shen-Ge Wang, Santa Clara, CA (US); Jian J. Ma, Carlsbad, CA (US)

(73) Assignee: QUALCOMM Mems Technologies, Inc., San Diego, CA (US)

(21) Appl. No.: 14/244,410

(22) Filed: Apr. 3, 2014

(51) Int. Cl. G09G 3/20; G09G 3/34

(52) U.S. Cl. CPC G09G 3/2066; G09G 3/2051; G09G 3/346; G09G 3/3466; G09G 2320/0242; G09G 2340/06

(57) ABSTRACT

This disclosure provides systems, methods and apparatus, including computer programs encoded on computer storage media, for displaying high bit-depth images using a hybrid image dithering method that combines aspect of spatial error diffusion and temporal dithering on display devices including display elements that can display multiple primary colors. Various implementations of the hybrid image dithering method includes a temporal dithering method in which the error associated with selecting the primary color for each sub-frame is diffused to the subsequent sub-frame and diffusing any residual error in the last sub-frame spatially to one or more neighboring pixels

### TECHNICAL FIELD

This disclosure relates to methods and systems for displaying an input image using hybrid spatial and temporal dithering on display devices and more particularly on electromechanical systems based display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Digital images are commonly quantized into a plurality of grayscale or color levels for printing or displaying the digital images on a medium with limited tonescale resolution. Various techniques have been developed to reduce errors associated with quantization and to create the illusion of continuous-tone imagery in printed and displayed images.

Halftoning techniques have been developed to create the illusion of continuous-tone images on display devices that display a finite number of tones (for example, colors). For example, halftoning techniques can be used to display or print high resolution images (e.g. images having 24 bits per pixel, 8 bits per color channel) on a medium (e.g. a display device) having lower resolution (e.g. 2 or 4 bits per color channel). Examples of common halftoning techniques include spatial or temporal dithering and error diffusion.

Some display devices, such as, for example EMS systems based display devices, can produce an input color by utilizing more than three primary colors. Each of the primary colors can have reflectance or transmittance characteristics that are independent of each other. Such devices can be referred to as multi-primary display devices. In multi-primary display devices there may be more than one combination of the multiple primary colors to produce the same color having input color values, such as red (R), green (G), and blue (B) values. Halftoning techniques including spatial or temporal dithering and error diffusion can be applied to display color images on multi-primary display devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus comprising a display device including a plurality of display elements and a hardware processor capable of communicating with the display device. Each display element is capable of displaying one of N discrete primary colors in a color space associated with the display device at a given time. The processor is capable of processing incoming image data including a plurality of input colors for display by the display device. The image data includes a plurality of image pixels. For each image pixel, the processor is capable of identifying M primary colors. The M primary colors when temporally dithered produce a color that is perceptually similar to an input color (C) of the image pixel. The variable M represents a number of sub-frames for temporal dithering including a first sub-frame and a last sub-frame. In various implementations, the target color for the first sub-frame can be equal to the input color (C).

For a given sub-frame, the processor is capable of determining in a color space an error that corresponds to a difference in color values between a primary color selected for the given sub-frame and a target color for the given sub-frame and diffusing the error to a subsequent sub-frame. The processor is further capable of spatially diffusing any residual error at the last sub-frame in the color space to one or more neighboring input image pixels.

In various implementations of the apparatus, for the first sub-frame, the processor can be capable of selecting a first primary color (P1) in the color space associated with the display device that closely matches the input color (C) of the image pixel; determining in the color space, an error (e1) that corresponds to a difference in color values between the first primary color (P1) in the color space and the input color (C) of the image pixel; and adding the error (e1) to the input color (C) to obtain a modified input color (C′) of the image pixel. For each sub-frame i subsequent to the first sub-frame, the processor can be capable of selecting an i-th primary color (Pi) in the color space associated with the display device that closely matches the modified input color (C′i-1) of the image pixel obtained in the previous sub-frame; determining in the color space an error (ei) that corresponds to a difference in color values between the i-th primary color (Pi) in the color space and the modified input color (C′i-1) of the image pixel obtained in the previous sub-frame; and adding the error (ei) to the modified input color (C′i-1) of the image pixel obtained in the previous frame to obtain a different modified input color (C′i) for the i-th sub-frame.

In various implementations of the apparatus an amount of the residual error that is diffused to neighboring input image pixels can be determined by spatial error diffusion. In various implementations of the apparatus, a number of primary colors N can be at least 2. In various implementations of the apparatus, the number of sub-frames M can be at least 2. In various implementations of the apparatus, the display device can be a reflective display device. In various implementations of the apparatus, at least some of the plurality of display elements can include a movable mirror. In various implementations of the apparatus, each of the N primary colors can correspond to a position of the movable mirror. In various implementations of the apparatus, the display device can be capable of operating at a frame rate less than a threshold frame rate and without using temporal dithering. In various implementations of the apparatus, the processor can be capable of communicating with an output frame buffer that stores indices corresponding to the selected M primary colors for each of the input image pixels. In various implementations of the apparatus, the processor can be capable of reconstructing incoming image data by processing the stored indices corresponding to the selected M primary colors for each of the input image pixels.

Another innovative aspect of the subject matter described in this disclosure can be implemented in a computer-implemented method to display an incoming image data including a plurality of input colors on a display device. The image data includes a plurality of image pixels. The method is performed under control of a hardware computing device. The method comprises identifying M primary colors for a given image pixel to be displayed in M sub-frames by temporal dithering. The M primary colors when temporally dithered produce a color that is perceptually similar to an input color (C) of the given image pixel. The method further comprises calculating in a color space an error (ei) that corresponds to a difference in color values between a primary color selected for an i-th sub-frame and a target color for the i-th sub-frame; diffusing the error (ei) to a subsequent sub-frame; and spatially diffusing a residual error (e) that corresponds to a difference in color values between a primary color selected for the M-th sub-frame and a target color for the last sub-frame to one or more neighboring image pixels. In various implementations of the method the M primary colors can be selected from a number N of discrete colors that can be produced by each of a plurality of display elements of the display device. In various implementations of the method a number of primary colors N can be at least 2. In various implementations of the method a number of sub-frames M can be at least 2.

Another innovative aspect of the subject matter described in this disclosure can be implemented in a non-transitory computer storage medium comprising instructions that when executed by a processor cause the processor to perform a method to display an incoming image data including a plurality of input colors on a display device. The image data includes a plurality of image pixels. The method is performed under control of a hardware computing device. The method comprises identifying M primary colors for a given image pixel to be displayed in M sub-frames by temporal dithering. The M primary colors when temporally dithered produce a color that is perceptually similar to an input color (C) of the given image pixel. The method further comprises calculating in a color space an error (ei) that corresponds to a difference in color values between a primary color selected for an i-th sub-frame and a target color for the i-th sub-frame; diffusing the error (ei) to a subsequent sub-frame; and spatially diffusing a residual error (e) that corresponds to a difference in color values between a primary color selected for the M-th sub-frame and a target color for the last sub-frame to one or more neighboring image pixels. The M primary colors can be selected from a number N of discrete colors that can be produced by each of a plurality of display elements of the display device. A number of primary colors N can be at least 2. A number of sub-frames M can be at least 2.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5 is a flow diagram illustrating a manufacturing process for an IMOD display or display element.

FIGS. 6A-6E are cross-sectional illustrations of various stages in a process of making an IMOD display or display element.

FIGS. 7A and 7B are schematic exploded partial perspective views of a portion of an electromechanical systems (EMS) package including an array of EMS elements and a backplate.

FIG. 8 shows a cross-section of an implementation of an analog IMOD (AIMOD).

FIG. 9A shows an example of different primary colors produced by an implementation of a multi-primary display element. FIG. 9B depicts the locations of the different primary colors shown in FIG. 9A in the International Commission on Illumination (CIE) L*a*b* color space.

FIGS. 10A-10C illustrate examples of the possible color combinations of the selected primary colors illustrated in FIG. 9A in the CIE L*a*b* color space that are produced by temporal dithering with 2, 3 and 4 sub-frames respectively.

FIG. 11 is a functional diagram that describes an example of a method to display images on an implementation of a multi-primary display element using spatial error-diffusion.

FIG. 12A is a functional diagram that describes an implementation of a hybrid image dithering method using an input frame buffer. FIG. 12B is a functional diagram that describes an implementation of a hybrid image dithering method using an output frame buffer. FIG. 12C is a functional diagram that describes an implementation of a method to retrieve an input image from the output buffer.

FIG. 13 is a flow chart that describes an implementation of a hybrid image dithering method.

FIGS. 14A and 14B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

The systems and methods described herein can be used to display high bit-depth color images (e.g., images having 8 bits per color channel) on a multi-primary display device including a plurality of display elements that have lower color bit-depth (for example, 1, 2 or 4 bits per color channel). Each display element of the multi-primary display device is capable of displaying N primary colors in a color space associated with the display device. An incoming image including a plurality of colors in a perceptual color space can be displayed on a multi-primary display device using a combination of spatial error diffusion methods and temporal dithering with M temporal sub-frames. For example, the color of an input image pixel can be represented as a combination of M primary colors which are cycled at a rate greater than the rate at which the human visual system is capable of detecting the different primary colors. When the M primary colors have color levels or tones different from the color level or tone of the color of the input image pixel, the displayed color can be different from the input color. The difference between the displayed color and the input color can be referred to as an error. In various systems and methods described herein, the error associated with selecting the primary color for each sub-frame is diffused to the subsequent sub-frame. The residual error from the last sub-frame is spatially diffused to one or more neighboring pixels of the input image using spatial error diffusion schemes (e.g., Floyd-Steinberg dithering algorithm, Jarvis algorithm, etc.). Accordingly, to closely reproduce the input color on a multi-primary display device a hybrid scheme can be adopted, which includes aspects of error diffusion in the temporal domain and error diffusion in the spatial domain.

A particular implementation of the hybrid scheme that maps each pixel of the incoming image that corresponds to a color in a perceptual color space onto a corresponding display element includes: (i) selecting a first primary color in the color space associated with the display device that closely matches the color of the incoming image pixel for displaying in the first sub-frame; (ii) calculating an error in a perceptual color space between the first primary color and the color of the input image pixel; (iii) adding the error to the color of the image pixel to obtain a modified input color level and selecting a second primary color in the color space associated with the display device to be displayed in the second sub-frame, the second primary color selected to closely match the modified input color level; and (iv) repeating the error calculation and the primary color selection process M times. Without any loss of generality, a color can closely match another color if the two colors are perceptually similar to the other color. Without any loss of generality, a color can closely match another color if the two colors are with a neighborhood of each other in a color space. The error associated with selecting the first primary color to be displayed in the first sub-frame is diffused to the subsequent sub-frames so as to produce a combination color that closely matches the color of the input image pixel using temporal dithering. The color resolution of the displayed image can be further enhanced by diffusing any residual error after temporal dithering to neighboring pixels using the techniques of spatial error diffusion.

Particular implementations of the subject matter described in this disclosure can be implemented to realize one or more of the following potential advantages. It is possible to display high bit-depth digital images on display devices having low native bit-depth multiple primary colors, and to render intermediate tones that cannot be natively displayed by the display device. Combining error diffusion in the temporal and spatial domains can increase color resolution of displayed images. Combining error diffusion in the temporal and spatial domains can decrease visible halftone artifacts that can degrade the quality of displayed images.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

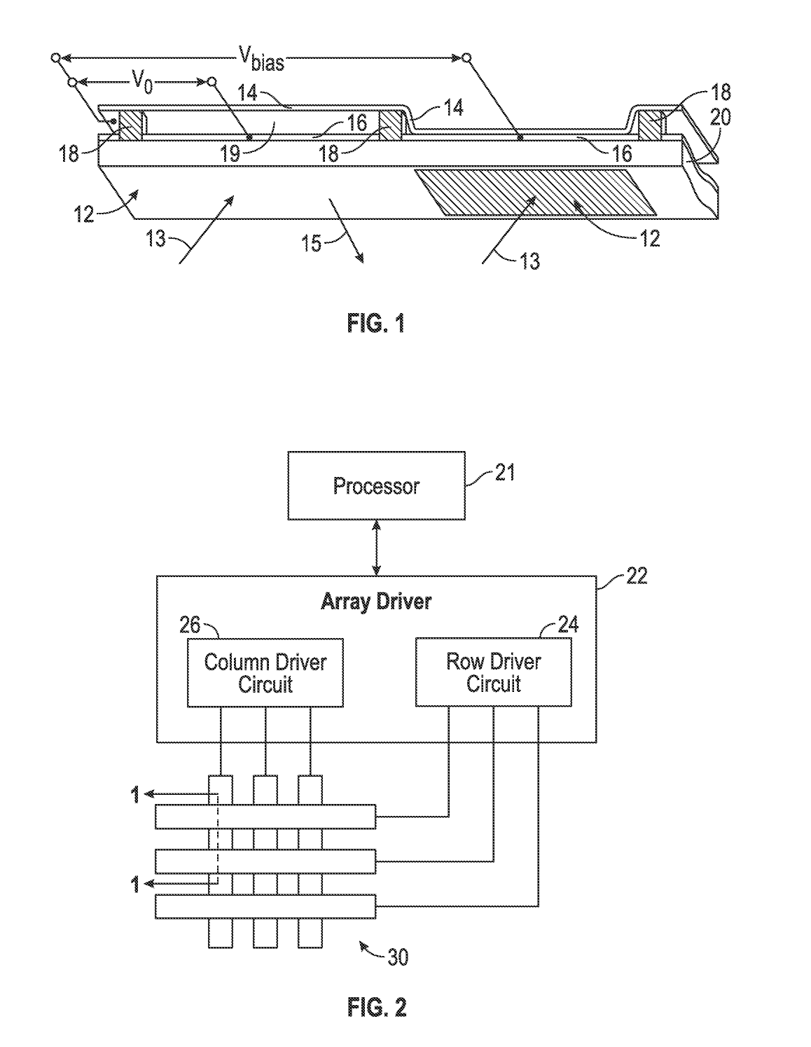

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposlited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

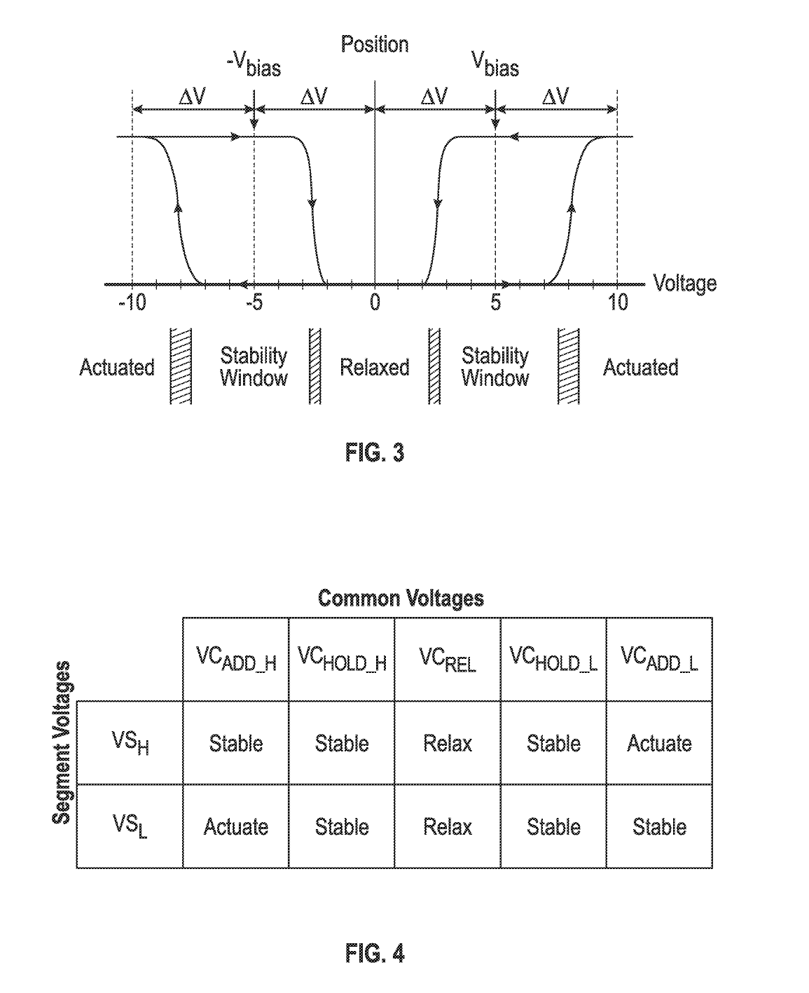

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

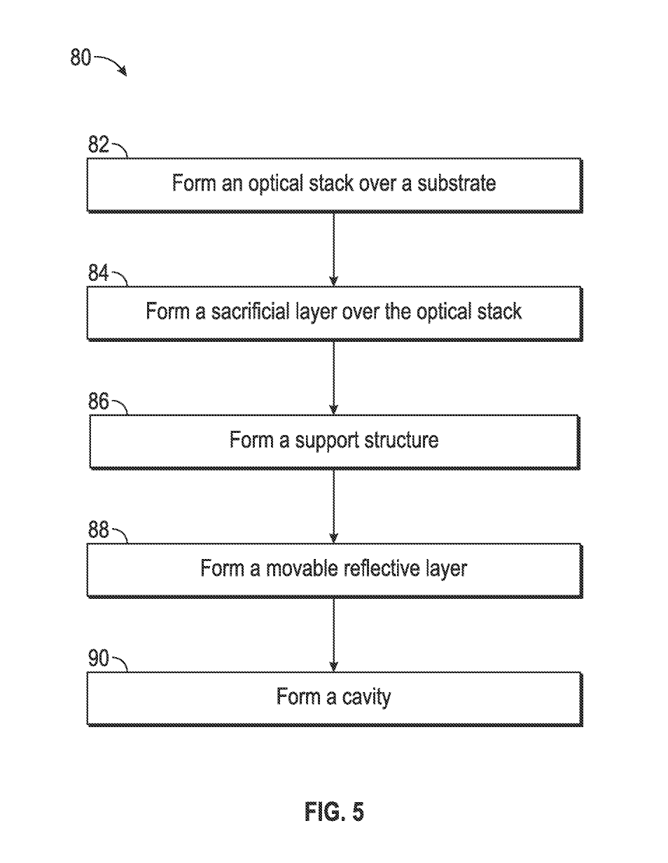

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

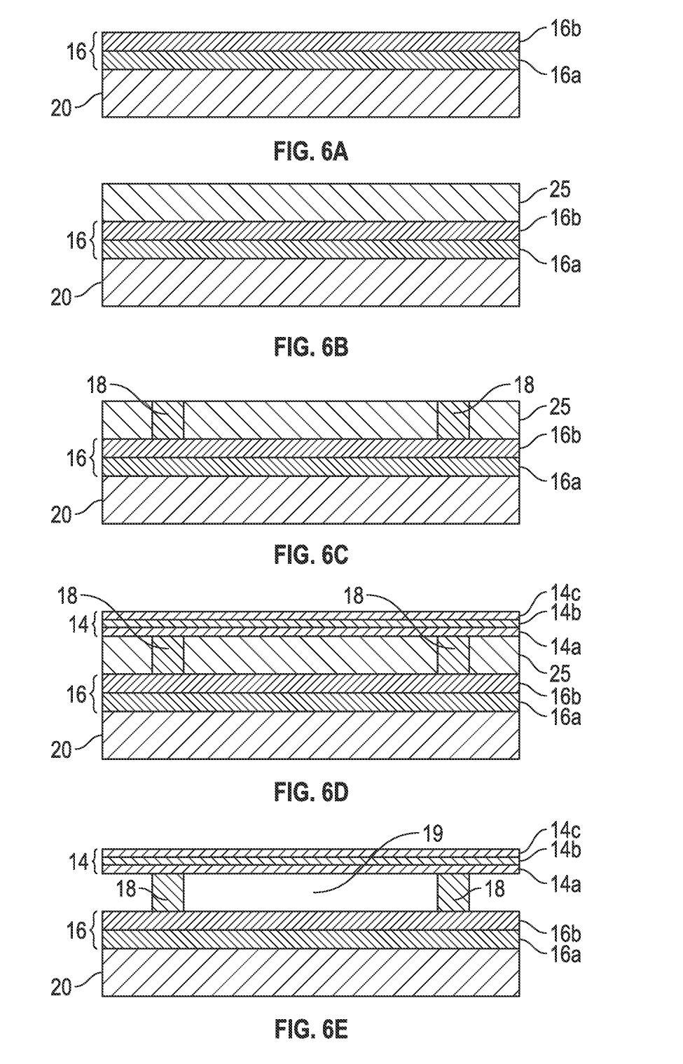

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

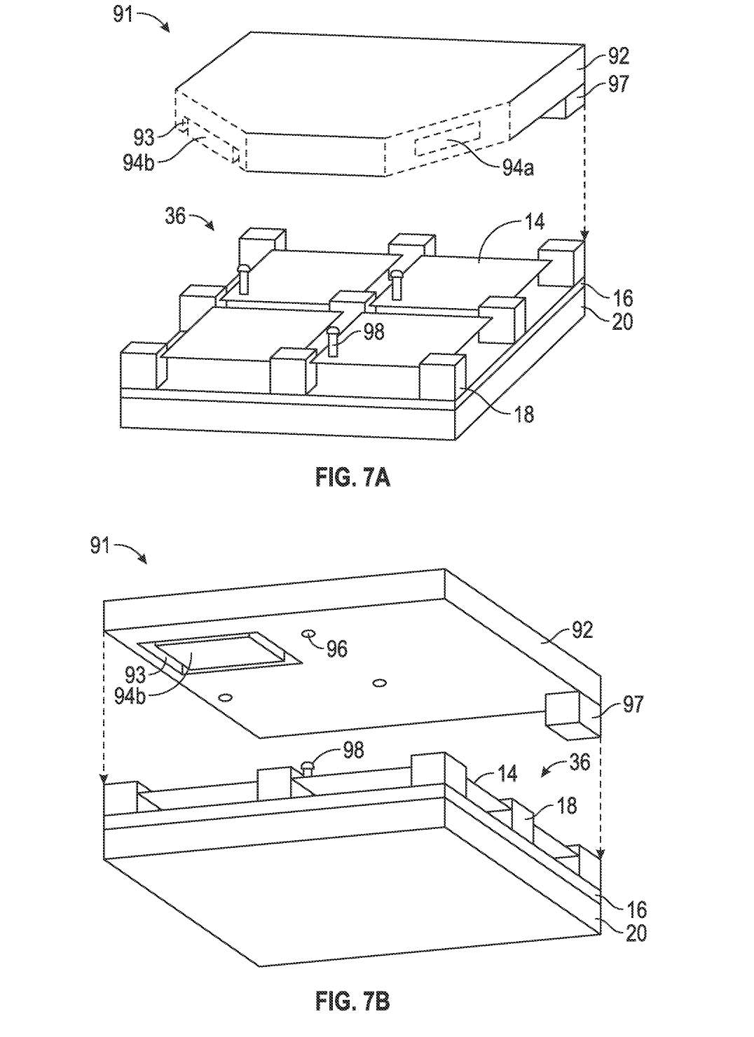

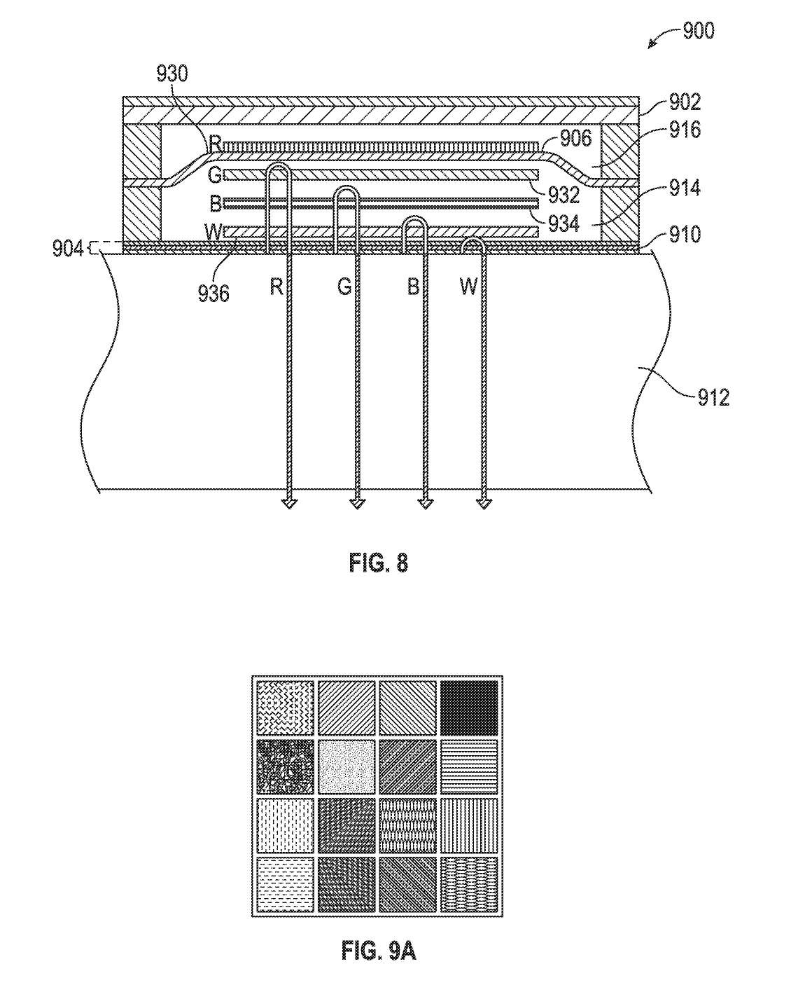

FIG. 5 is a flow diagram illustrating a manufacturing process 80 for an IMOD display or display element. FIGS. 6A-6E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 5. The process 80 begins at block 82 with the formation of the optical stack 16 over the substrate 20. FIG. 6A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 6A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 6A-6E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 6B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 6E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 6C, the aperture formed in the sacrificial layer 25 can extend through the sacrificial layer 25, but not through the optical stack 16. For example, FIG. 6E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 6C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 6D. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 6D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

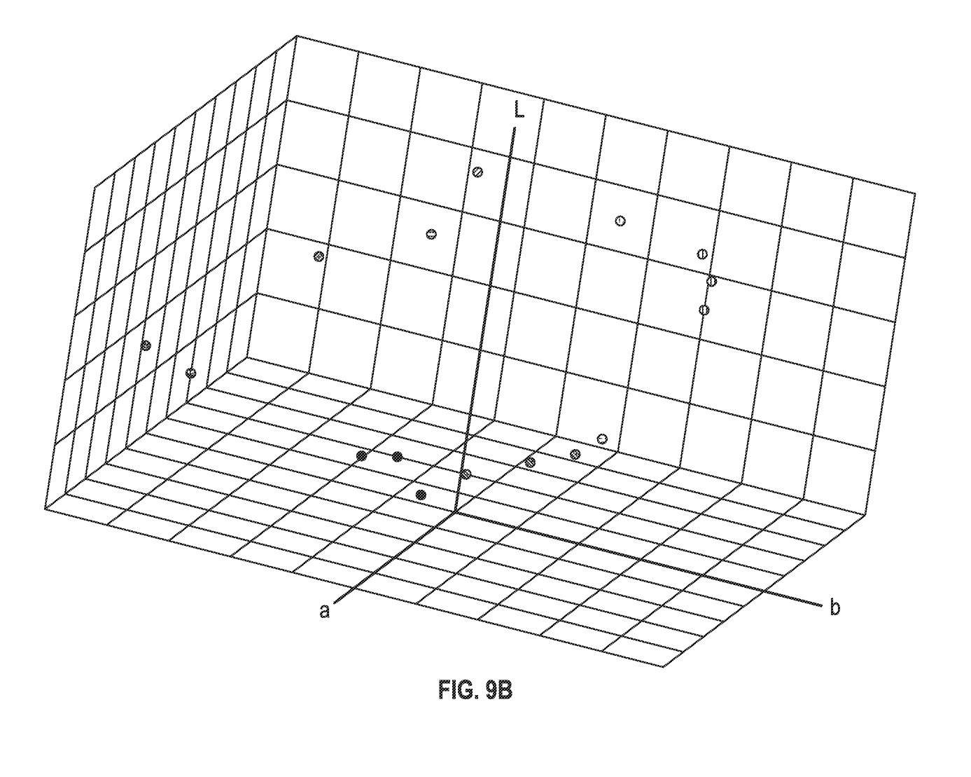

FIGS. 7A and 7B are schematic exploded partial perspective views of a portion of an EMS package 91 including an array 36 of EMS elements and a backplate 92. FIG. 7A is shown with two corners of the backplate 92 cut away to better illustrate certain portions of the backplate 92, while FIG. 7B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 7A and 7B, the backplate 92 can include one or more backplate components 94a and 94b, which can be partially or wholly embedded in the backplate 92. As can be seen in FIG. 7A, backplate component 94a is embedded in the backplate 92. As can be seen in FIGS. 7A and 7B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 7B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 7A and 7B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 7A and 7B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

Various implementations of a multi-primary display device can include the EMS array 36. The EMS elements in the array can include one or more IMODs. In some implementations the IMOD can include an analog IMOD (AIMOD). The AIMOD may be configured to selectively reflect multiple primary colors and provide 1 bit per color.

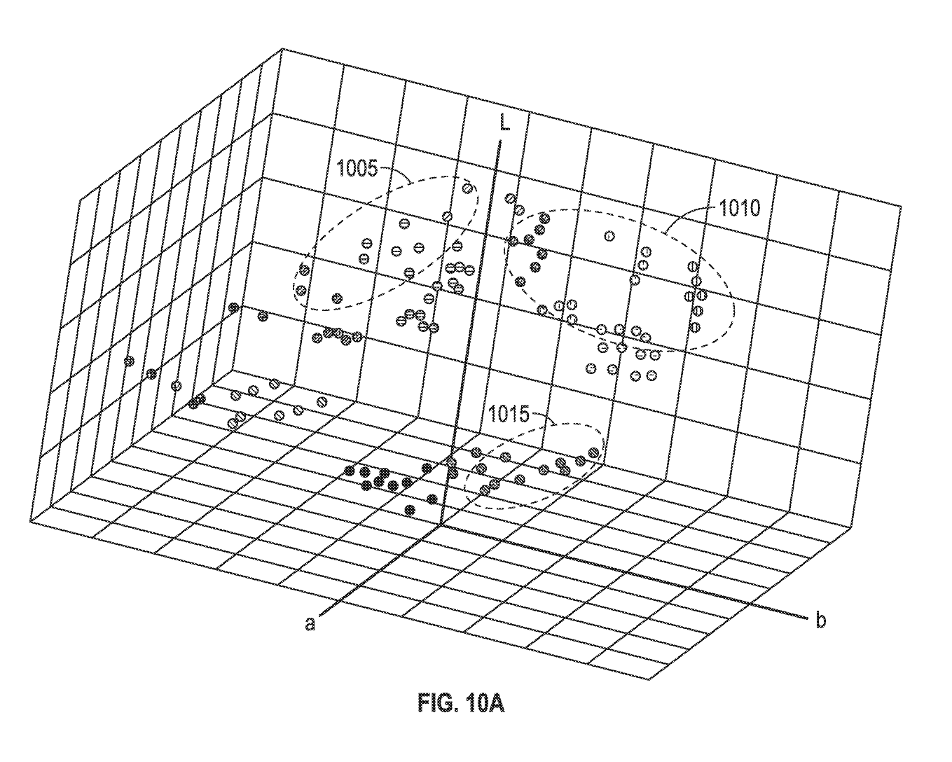

FIG. 8 shows a cross-section of an implementation of an AIMOD. The AIMOD 900 includes a substrate 912 and an optical stack 904 disposed over the substrate 912. The AIMOD includes a first electrode 910 and a second electrode 902 (as illustrated, the first electrode 910 is a lower electrode, and second electrode 902 is an upper electrode). The AIMOD 900 also includes a movable reflective layer 906 disposed between the first electrode 910 and the second electrode 902. In some implementations, the optical stack 904 includes an absorbing layer, and/or a plurality of other layers. In some implementations, and in the example illustrated in FIG. 8, the optical stack 904 includes the first electrode 910 which is configured as an absorbing layer. In such a configuration, the absorbing layer (first electrode 910) can be an approximately 6 nm layer of material that includes MoCr. In some implementations, the absorbing layer (that is, the first electrode 910) can be a layer of material including MoCr with a thickness ranging from approximately 2 nm to 50 nm.

The reflective layer 906 can be actuated toward either the first electrode 910 or the second electrode 902 when a voltage is applied between the first and second electrodes 910 and 902. In this manner, the reflective layer 906 can be driven through a range of positions between the two electrodes 902 and 910, including above and below a relaxed (unactuated) state. For example, FIG. 8 illustrates that the reflective layer 906 can be moved to various positions 930, 932, 934 and 936 between the first electrode 910 and the second electrode 902.

The AIMOD 900 in FIG. 8 has two structural cavities, a first cavity 914 between the reflective layer 906 and the optical stack 904, and a second cavity 916 between the reflective layer 906 and the second electrode 902. In various implementations, the first cavity 914 and/or the second cavity can include air. The color and/or intensity of light reflected by the AIMOD 900 is determined by the distance between the reflective layer 906 and the absorbing layer (first electrode 910).

The AIMOD 900 can be configured to selectively reflect certain wavelengths of light depending on the configuration of the AIMOD. The distance between the first electrode 910, which in this implementation acts as an absorbing layer and the reflective layer 906 changes the reflective properties of the AIMOD 900. Any particular wavelength is maximally reflected from the AIMOD 900 when the distance between the reflective layer 906 and the absorbing layer (first electrode 910) is such that the absorbing layer (first electrode 910) is located at the minimum light intensity of standing waves resulting from interference between incident light and light reflected from the reflective layer 906. For example, as illustrated, the AIMOD 900 is designed to be viewed from the substrate 912 side of the AIMOD (through the substrate 912), that is, light enters the AIMOD 900 through the substrate 912. Depending on the position of the reflective layer 906, different wavelengths of light are reflected back through the substrate 912, which gives the appearance of different colors. These different colors are also referred to as native or primary colors. The number of primary colors produced by the AIMOD 900 can be greater than 4. For example, the number of primary colors produced by the AIMOD 900 can be 5, 6, 8, 10, 16, 18, 33, etc.

A position of the movable layer 906 at a location such that it reflects a certain wavelength or wavelengths can be referred to as a display state of the AIMOD 900. For example, when the reflective layer 906 is in position 930, red wavelengths of light are reflected in greater proportion than other wavelengths and the other wavelengths of light are absorbed in greater proportion than red. Accordingly, the AIMOD 900 appears red and is said to be in a red display state, or simply a red state. Similarly, the AIMOD 900 is in a green display state (or green state) when the reflective layer 906 moves to position 932, where green wavelengths of light are reflected in greater proportion than other wavelengths and the other wavelengths of light are absorbed in greater proportion than green. When the reflective layer 906 moves to position 934, the AIMOD 900 is in a blue display state (or blue state) and blue wavelengths of light are reflected in greater proportion than other wavelengths and the other wavelengths of light are absorbed in greater proportion than blue. When the reflective layer 906 moves to a position 936, the AIMOD 900 is in a white display state (or white state) and a broad range of wavelengths of light in the visible spectrum are substantially reflected such that and the AIMOD 900 appears “gray” or in some cases “silver,” and having low total reflection (or luminance) when a bare metal reflector is used. In some cases increased total reflection (or luminance) can be achieved with the addition of dielectric layers disposed on the metal reflector, but the reflected color may be tinted with blue, green or yellow, depending on the exact position of 936. In some implementations, in position 936, configured to produce a white state, the distance between the reflective layer 906 and the first electrode 910 is between about 0 and 20 nm. In other implementations, the AIMOD 900 can take on different states and selectively reflect other wavelengths of light based on the position of the reflective layer 906, and also based on materials that are used in construction of the AIMOD 900, particularly various layers in the optical stack 904.

The multiple primary colors displayed by a display element (for example, AIMOD 900) and the possible color combinations of the multiple primary colors displayed by a display element can represent a color space associated with the display element. A color in the color space associated with the display device can be identified by a color level that represents tone, grayscale, hue, chroma, saturation, brightness, lightness, luminance, correlated color temperature, dominant wavelength, or a coordinate in the color space associated with the display element.

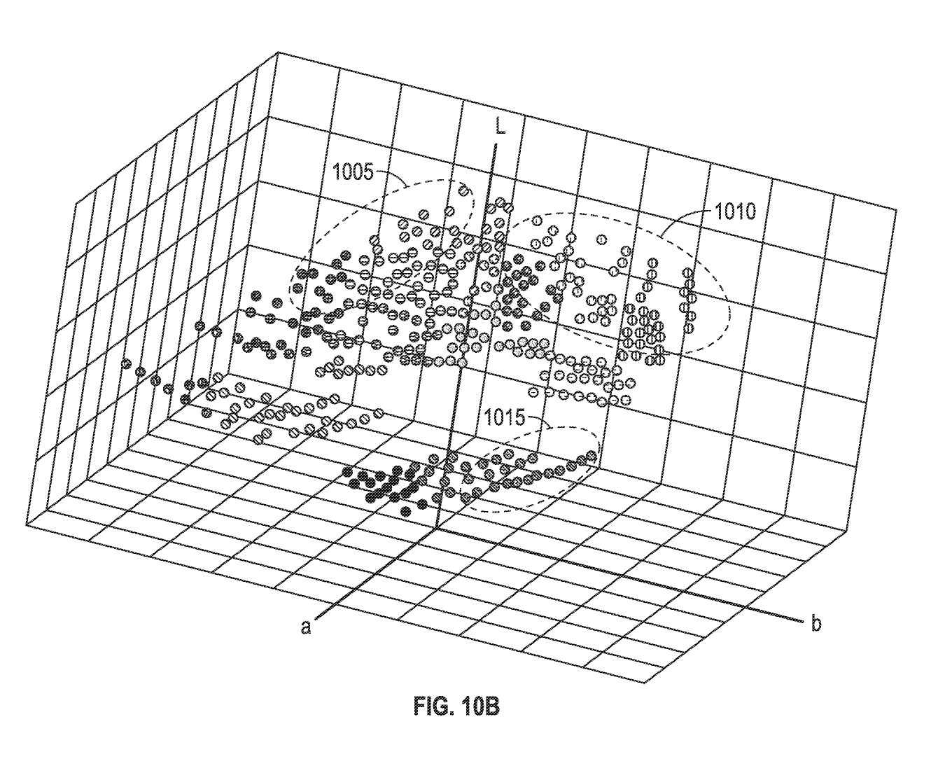

FIG. 9A shows an example of different primary colors produced by an implementation of a multi-primary display element (for example, AIMOD 900). FIG. 9B depicts the locations of the different primary colors shown in FIG. 9A in the International Commission on Illumination (CIE) L*a*b* color space. FIG. 9A depicts sixteen (16) discrete primary colors that are selected from the plurality of primary colors that can be generated by the display element. Various methods can be used to select the discrete primary colors. For example, in some implementations, the discrete primary colors can be selected from a spiral curve in the color space associated with the display element. By spatial and/or temporal mixing of the selected discrete primary colors, the human visual system can perceive a more complete spectrum of colors as a result of color blending. For example, using temporal dithering with four temporal frames and black and white colors, five colors including three gray levels can be displayed. As another example, using temporal dithering with two temporal frames and black, white and a non-black and non-white primary color (e.g., red, green or blue), six colors can be displayed. Many different color levels can be produced by including more primary colors and temporal frames. In this manner any color in a color space (e.g., CIE L*a*b* color space, sRGB color space, etc.) can be reproduced by blending the selected discrete primary colors. The color resolution of color produced by spatial modulation and/or temporal dithering can be increased by appropriately selecting values for spatial resolution and/or the temporal frame rate. Accordingly, spatial modulation and/or temporal dithering can be used to display high bit-depth color images (for example, with 8 bits per color channel or 256 color levels per color channel) on a multi-primary display device having lower color bit-depth (for example, 1, 2 or 4 bits per color channel). Methods of displaying images on a multi-primary display device using temporal dithering and spatial error diffusion are discussed in detail below.

### Temporal Dithering Method to Display Color Images

Temporal dithering can be employed to display an input image including a plurality of image pixels on an implementation of a multi-primary display device (for example, AIMOD 900). The display element can produce a plurality of primary colors. A number (N) of discrete primary colors from the plurality of primary colors can be selected for temporal dithering. In various implementations, the N discrete primary colors can be a subset of the plurality of primary colors. In various implementations, the number N of discrete primary colors can be at least 2. In various implementations, the number N of discrete primary colors can be 2, 3, 4, 6, 8, 12, 16, 33, etc. In various implementations, the N discrete primary colors can be similar to the sixteen colors depicted in the example shown in FIG. 9A. A display element corresponding to an input image pixel can be configured to display at least two primary colors selected from the N discrete primary colors. In various implementations, the at least two primary colors can be the same or substantially similar colors. The at least two primary colors displayed by the display element can be cyclically changed (e.g., the two colors are displayed alternately) at a fast display frame rate. Since, human visual system cannot resolve repeated changing patterns, if the changing frequency is greater than about 15 Hz (e.g., 30 Hz or 40 Hz), the perceived colors produced by the temporal dithering would be the averaged color of the at least two primary colors displayed by each pixel. For example, if the overall frame rate is 120 Hz, it is possible to display a plurality (e.g., hundreds or thousands) of different perceived colors by cyclically displaying four primary colors in four sub-frames cycled at 30 Hz, three primary colors in three sub-frames cycled at 40 Hz or two primary colors in two sub-frames cycled at 60 Hz. In other words the human visual system can perceive a plurality (e.g., hundreds or thousands) of different colors when M primary colors selected from the N discrete primary colors are displayed in M sub-frames which are cycled at a frequency greater than 15 Hz. In various implementations, some or all of the M primary colors can be the same or substantially similar colors. In various implementations, some of the M primary colors can be the same and some can be different. In various implementations, the M primary colors can be different. In various implementations, a number of sub-frames M can have a value between 2 and 32 (e.g., 2, 3, 4, 6 or 8). The number of sub-frames M can be less than, equal to, or greater than the number of primary colors N. In implementations where the display elements of the multi-primary display device are capable of reflectively displaying two or more primary colors, there may be little cross-interference between neighboring display elements. In such implementations, the color displayed when a few primary colors are cycled through with equal intervals of time between each primary color can be obtained by simply taking the average color of these primaries, for example, in a linear color space such as the CIE L*a*b* color space.

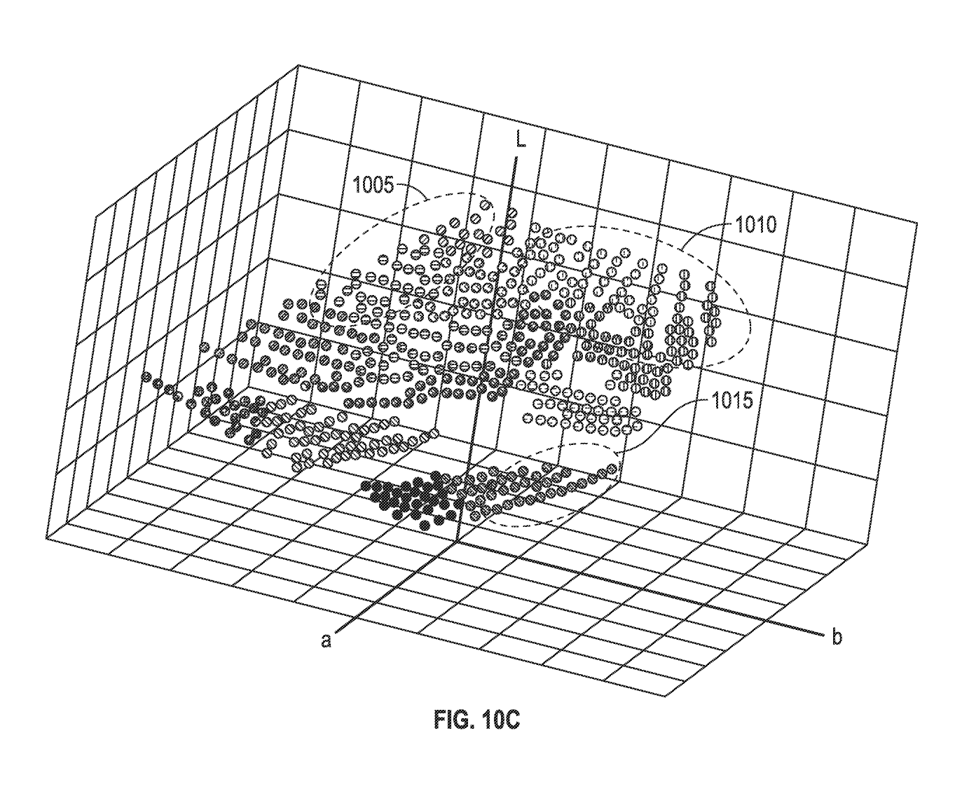

FIGS. 10A-10C illustrate the possible color combinations of the selected primary colors illustrated in FIG. 9A in the CIE L*a*b* color space that are produced by an example implementation of temporal dithering with 2, 3 and 4 sub-frames respectively. In FIGS. 10A-10C, region 1005 represents colors in the blue spectral range, region 1010 represents colors in the green spectral range and region 1015 represents colors in the red spectral range. It is observed from FIGS. 10A-10C that the total number of perceived colors (for example, in regions 1005, 1010 and 1015) increases as the number of sub-frames increases. In various implementations of a multi-primary display device, a higher frame rate may be required to blend more sub-frames in the time domain. Since the processor requirement to support higher frame rates may not be practically achievable, there may be an upper limit for the number of sub-frames (e.g., 2, 3, 4, 8, 16 or 32) for temporal dithering in most practical applications. The CIE L*a*b* space is a uniform color space, where, a distance change at any point in any direction corresponds to the same relative perceptual difference. Since, the perceived colors produced by temporal dithering are not “evenly” distributed in the CIE L*a*b* color space, as observed from FIGS. 10A-10C, temporal dithering with 2, 3 and 4 sub-frames of the selected primary colors may not be capable of producing some colors in the CIE L*a*b* color space. Thus, the displayed image generated by temporal dithering with 2, 3 and 4 sub-frames of the selected primary colors can have lower color resolution than the input image.

Moreover, in various implementations of multi primary display devices, the color levels of the multiple primary colors in the color space associated with the display device may not correspond to the color level of a corresponding color in a perceptual color space such as, for example a CIE L*a*b* color space. For example, the level or the tone of a red primary color in the color space associated with the display device may be different from the level or the tone of red color in the perceptual color space. Accordingly, when an input image including a plurality of colors in a perceptual color space is mapped onto the various display elements, the displayed output may not appear to be visually pleasing, even with the use of temporal dithering.

Furthermore, the displayed color can be different from the input color if the selected primary colors have color levels or tones different from the color level or tone of the color of the input image pixel. The difference in the displayed color and the input color can be referred to as an error. In various implementations, the error associated with selecting the primary color for each sub-frame can be diffused to the subsequent sub-frame, as discussed below, to reduce the error between the input color and the color displayed by temporal dithering.

### Spatial Error Diffusion Method to Display Color Images

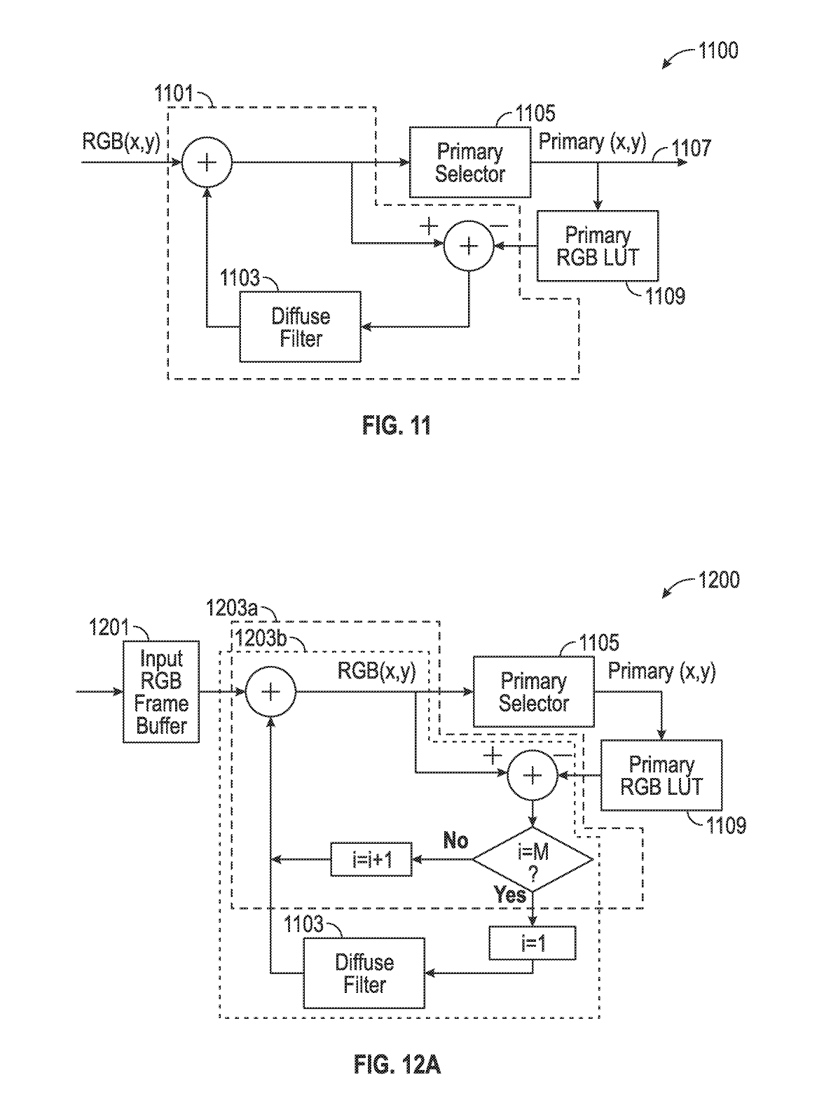

There exist several different methods for spatial color blending that are used in a variety of applications, such as, for example, digital printing or digital displays. FIG. 11 is a functional diagram that describes an implementation of a method 1100 to display images on an implementation of a multi-primary display element (for example, AIMOD 900) using spatial error-diffusion. The various functional blocks illustrated in FIG. 11 can be implemented with processors executing instructions included in a machine-readable non-transitory storage medium, such as a RAM, ROM, EEPROM, etc. The various functional blocks can be implemented with electronic processors, micro-controllers, FPGA's, etc. The input image can be a color image in the RGB color space and can include a plurality of image pixels. Each image pixel can be associated with a color C in the RGB color space. Each input image pixel is mapped onto a corresponding display element by selecting one of N discrete primary colors in the color space associated with the display element that can be produced by the display element and configuring the display element to display the selected primary color. In various implementations, the N discrete primary colors can be a subset of the plurality of primary colors that can be produced by the display element. In various implementations, a number N of discrete primary colors can be at least 2. In various implementations, a number N of discrete primary colors can be 2, 3, 4, 6, 8, 12, 16, 33, etc. In various implementations, the N discrete primary colors can be similar to the sixteen colors depicted in FIG. 9A. The output of the method 1100 illustrated in FIG. 11 is a one-channel image coded as primary indices for all the plurality of image pixels. If the number (N) of discrete primary colors selected is 16, then each pixel can be represented by 4 bits of data in the output image. To display an input image using the spatial error-diffusion method 1100 the input color Cᵢ in the RGB color space for the (i)^{th} input pixel is modified by adding diffused errors (e_{i-K}) from the feedback loop 1101 that includes a diffuse filter 1103. The modified color for the (i)^{th} input pixel can be represented as Cᵢ′.

The diffused errors can be generated by passing the difference between the selected primary color for the (i-K)^{th} input pixel and the input color C_{i-K} of the (i-K)^{th} input pixel in the RGB color space through the diffuser filter 1103. The functional block 1105 is a primary selector unit that can be used to compare the modified color Cᵢ′ for the (i)^{th} input pixel with the N discrete primary colors to choose the output primary color P, that is closest to the modified color Cᵢ′ for the (i)^{th} input pixel. Each primary color can be represented by a primary index including one or more bits. For the implementation, where the number (N) of discrete primary colors selected is 16, each primary color can be represented by a primary index with 4 bits. The primary index of selected output primary color Pᵢ for the (i)^{th} input pixel is sent to the output channel, as indicated by the arrow 1107. The difference between the selected primary color Pᵢ and the modified color Cᵢ′ (or the diffused error (eᵢ)) is calculated and sent to the feedback loop 1101. The diffused error is added to subsequent input pixels at a different spatial location. In various implementations, the diffused error can be added to one or more adjacent input pixels. In some implementations, the diffused error can be added to the next input pixel (or the (i+1)^{th} input input pixel). In some implementations, the diffused error can be added to subsequent input pixels in a neighborhood D of the (i)^{th} input pixel. In various implementations, D can have a value between 1 and 12, representing the number of subsequent pixels to which the error can be diffused. Any of a number of spatial diffusion methods can be used to diffuse the error to the subsequent pixels, such as Floyd-Steinberg diffusion, Jarvis diffusion, etc.

It may be desirable to determine the primary color Pᵢ that is closest to the modified color Cᵢ′ in a perceptually linear color space that resembles the human visual system, such as, for example, the CIE L*a*b* color space. Accordingly, in some implementations, a look-up-table (LUT) 1109 can be used to store the color in the perceptually linear color space that corresponds to each of the discrete primary colors.

### Hybrid Image Dithering Method to Display Color Images

As discussed above, the color of an input image pixel can be reproduced on a multi-primary display element using a hybrid scheme that includes aspects of error diffusion in the temporal domain and error diffusion in the spatial domain. Various implementations of the hybrid scheme includes a temporal dithering method in which the error associated with selecting the primary color for each sub-frame is diffused to the subsequent sub-frame and diffusing any residual error in the last sub-frame spatially to one or more neighboring pixels. Various implementations of the temporal dithering method include displaying M primary colors selected from N discrete primary colors in M sub-frames that are cyclically alternated at a fast frame rate. In various implementations, the M sub-frames can be spatially rendered from the same input image but with different halftones.

In various implementations, the M primary colors in a temporal dithering method with M sub-frames could be arranged differently in different pixels without affecting overall image appearance at a fast frame rate (for example, frame rate greater than or equal to 60 Hz). For example, in some implementations, the M primary colors can be assigned to sub-frames 1 to M according to the rank order of the brightness of the M primary colors to pixels in a first row; for sub-frames 2 to M and then sub-frame 1 according to the rank order of the brightness of the M primary colors to pixels in a second row; for sub-frames 3 to M and then sub-frames 1 and 2 according to the rank order of the brightness of the M primary colors to pixels in a third row; and so on. As another example, in some implementations, the M primary colors can be assigned to sub-frames 1 to M according to the rank order of the brightness of the M primary colors to pixels in a first row; for sub-frames 2 to M and then sub-frame 1 according to the rank order of the brightness of the M primary colors to pixels in a second row; for sub-frames 1 to M according to the rank order of the brightness of the M primary colors to pixels in a third row; and so on. Other spatial arrangements can also be used. Varying (for example, alternating) the assignment of the M primary colors from pixel to pixel can advantageously reduce flicker. For example, consider that the M primary colors are assigned to sub-frames 1 to M based on the rank order of the brightness of the M primary colors. If all the pixels follow such arrangement, the contrast between the brightest sub-frame and the darkest sub-frame can cause flicker, especially when viewed at lower frame rates (for example, frame rate greater than or equal to 60 Hz). The overall brightness of the M sub-frames can be at about the same level by varying the assignment of the primary colors between the M sub-frames for different pixels which in turn can reduce the flicker in viewing the temporal dithered image. Different spatial arrangements can reduce flicker to different levels. For example, when the number of sub-frames M is equal to 2 or 4, a checker-boarder pattern may be efficient in reducing flicker. In various implementations two or more different spatial arrangements can reduce flicker to the same level.

In various implementations, the input image can be a continuous-tone RGB image which may be represented by 24 or more bits for each pixel. For an implementation of a reflective display element capable of displaying a plurality of primary colors, (for example, AIMOD 900) each input image pixel can be mapped onto a corresponding display element by configuring the display element to display M primary colors selected from N discrete primary colors in M sub-frames. In various implementations, N can have a value equal to 2, 3, 4, 8, 16, or 33. The number of sub-frames M can be less than, equal to, or greater than the number of primary colors N. In various implementations, M can have a value equal to 2, 3, or 4.

Various implementations of temporal dithering can employ either an input frame buffer or an output frame buffer to cyclically repeat the M sub-frames. Described below are two different implementations of a hybrid image dithering method that combines spatial error-diffusion and temporal dithering. The first implementation uses an input frame buffer. The second implementation uses an output frame buffer. In other implementations, both an input buffer and an output buffer can be used.

### Hybrid Image Dithering Method Using an Input Frame Buffer

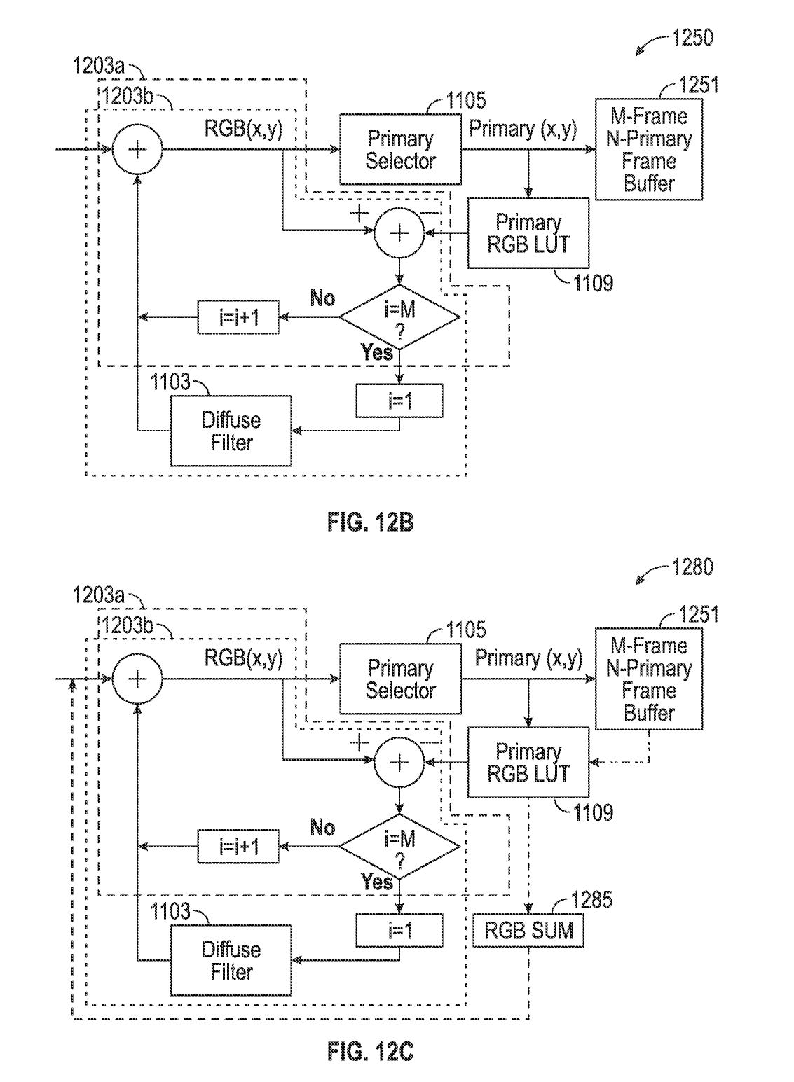

FIG. 12A is a functional diagram that describes an implementation of a hybrid image dithering method 1200 using an input frame buffer 1201. The hybrid image dithering method 1200 includes an input frame buffer 1201 that is configured to store the plurality of input image pixels. As discussed above, each input image pixel can be associated with a color level C in the RGB color space. The method 1200 includes two feed-back loops 1203a and 1203b. The feed-back loop 1203a is configured to select M primary colors for temporal dithering to be displayed in M sub-frames. As discussed above, the M primary colors can be selected from N discrete primary colors that can be produced by the display element. In various implementations, N can have a value equal to 2, 3, 4, 6, 8, 16, 32, etc. In various implementations, M can have a value equal to 2, 3, or 4. In various implementations, the M primary colors can be different from each at least one of the other colors. In various implementations, the M primary colors can be the same. In yet another implementation, some of the M primary colors can be the same. The feed-back loop 1203b is configured to spatially diffuse the residual error similar to the method 1100 discussed above. To display an input image using the method 1200, the input color Ci in the RGB color space for the (i)th input pixel is modified by adding diffused errors (e_{i-K}) from the feedback loop 1203b that includes a diffuse filter 1103. The modified color for the (i)th input pixel can be represented as Ci′. The diffused errors can correspond to the difference between the displayed color of the (i-K)th input pixel and the input color, C_{i-K} of the (i-K)th input pixel passed through the diffuse filter 1103.

The functional block 1105 can be used to select a first output primary color Pᵢ₁ to be displayed in the first sub-frame. In various implementations, the primary color Pᵢ₁ can be the closest primary color to the modified input color Cᵢ′. If the number of sub-frames M is greater than 1, the difference between the first output primary color Pᵢ₁ and the modified color Cᵢ′ (or the error (epᵢ)) is calculated and added to the modified input color Cᵢ′ via the feedback loop 1203a to obtain a second modified input color Cᵢ″. A second output primary color Pᵢ₂ to be displayed in the second sub-frame is selected using the primary selector 1105. The second output primary color Pᵢ₂ can be the closest primary color to the second modified input color Cᵢ″. In various implementations, the second output primary color Pᵢ₂ can, but need not, be different from the first output primary color Pᵢ₁. In some implementations, the second output primary color Pᵢ₂ can be the same as the first output primary color Pᵢ₁.

The operations of feed-back loop 1203a can be performed several times until M primary colors to be displayed in each of the M sub-frames are selected. The error associated with selecting the primary color for a previous sub-frame is taken into consideration while selecting the primary color for the current sub-frame. Accordingly, error associated with selecting the primary color for a sub-frame is diffused in the temporal domain to one or more subsequent sub-frames. The residual error after selecting the primary color P_{iM} to be displayed in the M^{th} sub-frame, is diffused to the neighboring pixels similar to the method 1100 of FIG. 11. It is noted that for M=1, the method 1200 is similar to the method 1100 of FIG. 11.

### Hybrid Image Dithering Method Using an Output Frame Buffer

FIG. 12B is a functional diagram that describes an implementation of a hybrid image dithering method 1250 using an output frame buffer 1251. The method 1250 can be used in those implementations, where it may not be practical to have an input frame buffer. Similar to the method 1200 of FIG. 12A, M primary colors Pᵢ₁, Pᵢ₂, . . . , P_{iM} to be displayed in each of the M sub-frames is selected for the (i)^{th} input pixel in the method 1250. As discussed above, the error associated with selecting the primary color for a previous sub-frame is taken into consideration while selecting the primary color for the current sub-frame. The residual error after selecting the primary color P_{iM} to be displayed in the M^{th} sub-frame, is diffused to the neighboring pixels similar to the methods 1100 of FIGS. 11 and 1200 of FIG. 12A. The index values for each of the selected M primary colors Pᵢ₁, Pᵢ₂, P_{iM} for each of the input image pixels are stored in the output frame buffer 1251 to be cyclically displayed in M sub-frames by temporal dithering.

Without any loss of generality, there is no significant difference in the quality of the displayed image using method 1200 and 1250. A possible advantage of the method 1250 is that a size of the output frame buffer can be smaller than a size of the input frame buffer. The size of the output frame buffer can depend on the number of selected discrete primary colors N and the number of sub-frames M for temporal dithering. For an implementation, with 16 primary colors and 4 sub-frames the colors of the output image pixel corresponding to each input image pixel can be represented by 16 bits. Thus, the size of the output frame buffer can be equal to 16 times the number of image pixels. On the other hand, if each input image pixel has at least 24 bits, then without image compression, the size of the input frame buffer to store RGB values for each of the input image pixels is at least 24 times the number of image pixels. Thus, the memory and processor requirements for a display device on which the method 1250 is implemented can be lower than memory and processor requirements for a display device on which the method 1200 is implemented.

Input Retrieval from an Output Frame Buffer

Methods of displaying images using temporal dithering can increase the color resolution and the overall image quality of the displayed images. However, configuring display elements to cyclically display one or more selected primary colors at a fast frame rate can consume more power than a static display mode that is always-on. In the always-on mode, an image is displayed at a frame rate less than 60 Hz such that the displayed image appears to be static over a period of time. For various applications, it may be desirable to have a mode selector option that can switch the display device between a static display mode in which temporal dithering is turned off and a dynamic mode in which temporal dithering is turned on. In the dynamic display mode a display state of some or all of the various display elements is changed such that the image is displayed at a frame rate greater than 60 Hz. For example, when the display device is not in use, the display device can be configured to be in a static mode in which the last image displayed by the display device (or another image) is retained on the display device without temporal dithering. The image displayed by the display device in the static mode can have a lower resolution than the resolution of the image displayed in the dynamic mode. The image displayed in the static mode can function in some aspects as a type of “screen saver” that displays an image rather than a blank screen. For various implementations of reflective displays, the continued display of an image in the static display mode uses little or no power; therefore, configuring the display device to switch between a static mode and a dynamic mode can be useful in conserving power. In various implementations, the display device is configured to automatically switch from the dynamic mode to the static display mode, for example, when user input has not been received for certain amount of time (e.g., when the device enters a sleep mode). In other implementations, the device can include a switch that responds to user input in order to activate the static display mode, for example, when the user actuates a switch to change the device from a wake mode to a sleep mode.

In implementations of a display device that include an input frame buffer, in the static mode, the plurality of image pixels of the input image stored in the input frame buffer can be mapped onto the plurality of display elements of the display device by configuring each of the display elements to display a color in the color space associated with the display device. In various implementations, an implementation of a spatial error diffusion method (e.g., method 1100) can be employed such that the color displayed by each display element is perceptually similar to the color of the corresponding image pixel. However, in implementations of a display device that only include an output frame buffer and do not include an input frame buffer, the input image can be reconstructed by retrieving the image from the output frame buffer.

FIG. 12C is a functional diagram that describes an implementation of a method 1280 to retrieve an input image from the output buffer 1251. When the display device is switched to a static mode, the M primary index values for each pixel stored in the output frame buffer are converted to RGB values by the using the look-up table 1109. An average RGB value is calculated as shown in block 1285. An image including a plurality of pixels, each pixel having a color equal to the calculated average RGB value can represent the retrieved input image. The retrieved input image can be mapped onto the corresponding display elements by configuring each display element to display a primary color in the display device color space that corresponds to the calculated RGB value. In various implementations, spatial error diffusion methods can be employed by modifying the calculated RGB value with error associated with processing a previous input pixel as discussed above.

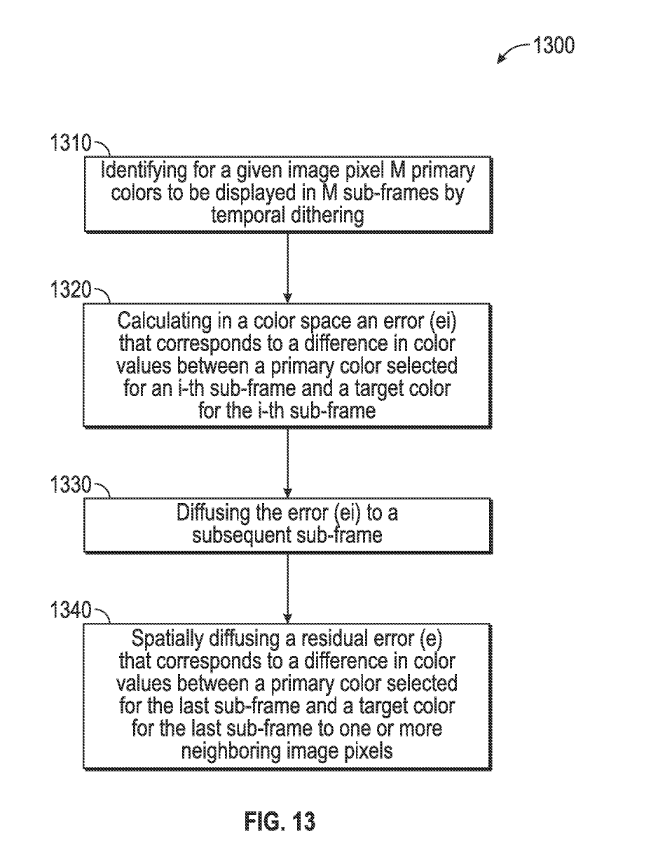

FIG. 13 is a flowchart that illustrates an example of a hybrid image dithering method 1300 that can be used to display an input image including a plurality of image pixels on a display device having a plurality of display elements, each display element configured to display one of N discrete primary colors in a color space associated with the display device at a given time. In various implementations, the N discrete primary colors can be a subset of the plurality of primary colors that can be produced by the display element. In various implementations, a number N of discrete primary colors can be at least 2. In various implementations, a number N of discrete primary colors can be 2, 3, 4, 6, 8, 12, 16, 33, etc. In various implementations, the N discrete primary colors can be similar to the sixteen colors depicted in FIG. 9A. Each of the plurality of image pixels can be associated with a color in the color space associated with the display device. As used herein, a color associated with each of the plurality of image pixels can include at least one of tone, grayscale, hue, chroma, saturation, brightness, lightness, luminance, correlated color temperature, dominant wavelength or a coordinate in the color space. In various implementations, the color associated with each of the plurality of image pixels can have a value between 0 and 255.

The display device can include a processor that is configured to communicate with the display device. In various implementations, the processor is configured to process incoming image data using the method 1300 to be displayed on the display device. The method 1300 includes identifying M primary colors to be displayed in M sub-frames by temporal dithering, as shown in block 1310. The M primary colors can produce a color that is perceptually similar to an input color (C) of the image pixel when temporally dithered. In various implementations, a number of sub-frames M can be at least 2. The method 1300 further includes calculating in a color space an error (ei) that corresponds to a difference in color values between a primary color (Pᵢ) selected for an (i)^{th} sub-frame and a target color for the (i)^{th} sub-frame, as shown in block 1320. The 1300 further includes diffusing the calculated (ei) to the subsequent sub-frame, as shown in block 1330. The method 1300 further includes spatially diffusing the residual error (e) that corresponds to a difference in color values between a primary color (P_{M}) selected for the last sub-frame and a target color for the last sub-frame to one or more neighboring image pixels, as shown in block 1340.

The method 1300 can be performed in its entirety by a physical computing device. The computing device can include a hardware processor and one or more buffers. A non-transitory computer readable storage medium can include instructions that can be executed by a processor in the physical computing device to perform the method 1300. In various implementations, the computing device and/or the non-transitory computer readable storage medium can be included with a system that includes a display device including a plurality of IMOD display elements including but not limited to implementations similar to AIMOD 900.

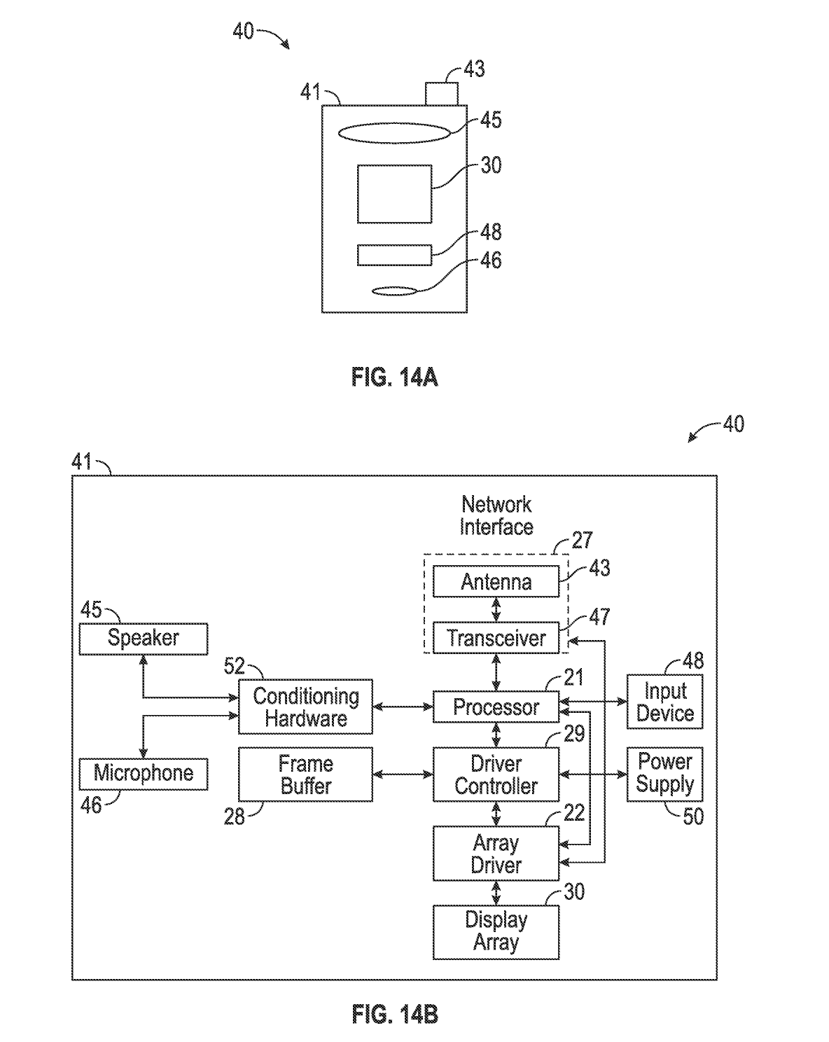

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time. For example, in some implementations using a large number of primary colors (e.g., greater than 3 primary colors) and several temporal frames (e.g., greater than 2), the number of possible color combinations can be very large (e.g., hundreds, thousands, or more possible colors) and a physical computing device may be necessary to select the appropriate combinations of primary colors to be displayed from the large number of possible colors. Accordingly, various implementations of the methods described herein (e.g., implementations of the methods 1100, 1200, 1251, 1280, 1300) can be performed by a hardware processor included in the display device (for example, the processor 21, the driver controller 29, and/or the array driver 22 described below with reference to the display device of FIGS. 14A and 14B).

To perform the methods described herein, the processor can execute a set of instructions stored in non-transitory computer storage. The processor can access a computer-readable medium that stores the indices for the primary colors and/or the last input image. A look-up table (LUT) can be used to store a correspondence between the display color and the set of primary colors. Various other implementations of the methods described herein can be performed by a hardware processor included in a computing device separate from the display device. In such implementations, the outputs of the methods can be stored in non-transitory computer storage and provided for use in a display device.

FIGS. 14A and 14B are system block diagrams illustrating a display device 40 that includes a plurality of IMOD display elements including but not limited to implementations similar to AIMOD 900. The display device 40 can be configured to use temporal (and/or spatial) modulations schemes that utilize the constrained color palette disclosed herein. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 14A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 14A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level. The processor 21 (or other computing hardware in the device 40) can be programmed to perform implementations of the methods described herein such as the methods 1100, 1200, 1251, and 1280. The processor 21 (or other computing hardware in the device 40) can be in communication with a computer-readable medium that includes instructions, that when executed by the processor 21, cause the processor 21 to perform implementations of the methods described herein such as the methods 1100, 1200, 1251, and 1280.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). The driver controller 29 and/or the array driver 22 can be an AIMOD controller or driver. In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described methods for generating a constrained color palette may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a display device including a plurality of display elements, each display element capable of displaying one of N discrete primary colors in a color space associated with the display device at a given time; and
a hardware processor capable of communicating with the display device, the processor capable of processing incoming image data including a plurality of input colors for display by the display device, the image data including a plurality of image pixels,
for each image pixel, the processor capable of identifying M primary colors, the M primary colors when temporally dithered producing a color that is perceptually similar to an input color (C) of the image pixel, wherein M represents a number of sub-frames for temporal dithering including a first sub-frame and a last sub-frame,
wherein for a given sub-frame, the processor is capable of:
determining in a color space an error that corresponds to a difference in color values between a primary color selected for the given sub-frame and a target color for the given sub-frame, and
diffusing the error to a subsequent sub-frame, and
wherein any residual error at the last sub-frame in the color space is spatially diffused to one or more neighboring input image pixels.

2. The apparatus of claim 1, wherein for the first sub-frame the target color is equal to the input color (C)

3. The apparatus of claim 1, wherein for the first sub-frame, the processor is capable of:
selecting a first primary color (P₁) in the color space associated with the display device that closely matches the input color (C) of the image pixel;
determining in the color space, an error (e₁) that corresponds to a difference in color values between the first primary color (P₁) in the color space and the input color (C) of the image pixel; and
adding the error (e₁) to the input color (C) to obtain a modified input color (C′) of the image pixel.

4. The apparatus of claim 3, wherein for each sub-frame i subsequent to the first sub-frame, the processor is capable of:
selecting an i-th primary color (Pᵢ) in the color space associated with the display device that closely matches the modified input color (C′ᵢ₋₁) of the image pixel obtained in the previous sub-frame;
determining in the color space an error (eᵢ) that corresponds to a difference in color values between the i-th primary color (Pᵢ) in the color space and the modified input color (C′ᵢ₋₁) of the image pixel obtained in the previous sub-frame; and
adding the error (eᵢ) to the modified input color (C′ᵢ₋₁) of the image pixel obtained in the previous frame to obtain a different modified input color (C′ᵢ) for the i-th sub-frame.

5. The apparatus of claim 1, wherein an amount of the residual error that is diffused to neighboring input image pixels is determined by spatial error diffusion.

6. The apparatus of claim 1, wherein a number of primary colors N is at least 2 and the number of sub-frames M is at least 2.

7. The apparatus of claim 1, wherein the display device is a reflective display device.

8. The apparatus of claim 7, wherein at least some of the plurality of display elements include a movable mirror.

9. The apparatus of claim 8, wherein each of the N primary colors corresponds to a position of the movable mirror.

10. The apparatus of claim 1, further comprising a driver circuit capable of sending at least one signal to the display device.

11. The apparatus of claim 10, further comprising a controller capable of sending at least a portion of the image data to the driver circuit.

12. The apparatus of claim 1, further comprising an image source module capable of sending the image data to the processor.

13. The apparatus of claim 12, wherein the image source module includes at least one of a receiver, transceiver, and transmitter.

14. The apparatus of claim 1, further comprising an input device capable of receiving input data and to communicate the input data to the processor.

15. The apparatus of claim 1, wherein the display device is capable of operating at a frame rate less than a threshold frame rate and without using temporal dithering.

16. The apparatus of claim 1, wherein the processor is capable of communicating with an input frame buffer that stores incoming image data.

17. The apparatus of claim 1, wherein the processor is capable of communicating with an output frame buffer that stores indices corresponding to the selected M primary colors for each of the input image pixels.

18. The apparatus of claim 17, wherein the processor is capable of reconstructing incoming image data by processing the stored indices corresponding to the selected M primary colors for each of the input image pixels.

19. A computer-implemented method to display an incoming image data including a plurality of input colors on a display device, the image data including a plurality of image pixels, the method comprising:
under control of a hardware computing device:
identifying M primary colors for a given image pixel to be displayed in M sub-frames by temporal dithering, the M primary colors when temporally dithered producing a color that is perceptually similar to an input color (C) of the given image pixel;
calculating in a color space an error (ei) that corresponds to a difference in color values between a primary color selected for an i-th sub-frame and a target color for the i-th sub-frame;
diffusing the error (ei) to a subsequent sub-frame; and
spatially diffusing a residual error (e) that corresponds to a difference in color values between a primary color selected for the M-th sub-frame and a target color for the last sub-frame to one or more neighboring image pixels.

20. The method of claim 19, wherein the M primary colors are selected from a number N of discrete colors that can be produced by each of a plurality of display elements of the display device.

21. The method of claim 20, wherein a number of primary colors N is at least 2 and the number of sub-frames M is at least 2.

22. A non-transitory computer storage medium comprising instructions that when executed by a processor cause the processor to perform a method to display an incoming image data including a plurality of input colors on a display device, the image data including a plurality of image pixels, the method comprising:
identifying M primary colors for a given image pixel to be displayed in M sub-frames by temporal dithering, the M primary colors when temporally dithered producing a color that is perceptually similar to an input color (C) of the given image pixel;
calculating in a color space an error (ei) that corresponds to a difference in color values between a primary color selected for an i-th sub-frame and a target color for the i-th sub-frame;
diffusing the error (ei) to a subsequent sub-frame; and
spatially diffusing a residual error (e) that corresponds to a difference in color values between a primary color selected for the M-th sub-frame and a target color for the last sub-frame to one or more neighboring image pixels.

23. The non-transitory computer storage medium of claim 22, wherein the M primary colors are selected from a number N of discrete colors that can be produced by each of a plurality of display elements of the display device.

24. The non-transitory computer storage medium of claim 23, wherein a number of primary colors N is at least 2 and the number of sub-frames M is at least 2.
